(19) United States
(12) Patent Application Publication
(10) Pub. No.: US 2014/0266705 A1
(43) Pub. Date: Sep. 18, 2014

(54) MULTIPLE-RADIO PENDANTS IN EMERGENCY ASSISTANCE SYSTEMS

(71) Applicant: SAFERAGING, INC., Reston, VA (US)

(72) Inventors: John McKINLEY, Great Falls, VA (US); Christopher WILLIAMS, Herndon, VA (US)

(73) Assignee: SAFERAGING, INC., Reston, VA (US)

(21) Appl. No.: 13/838,772

(22) Filed: Mar. 15, 2013

(51) Int. Cl. G08B 25/10

(52) U.S. Cl. CPC G08B 25/10
USPC 340/539.13; 340/539.11

(57) ABSTRACT

A system and method for reporting events in an emergency assistance system is provided. A main radio using a main wireless technology can be configured to communicate with the emergency assistance system. An additional secondary radio using a secondary wireless technology can provide additional or alternative communication with the emergency assistance system. Detected events can be reported to the emergency assistance system over a network connection with the emergency assistance system using the main radio or the secondary radio. This can be based on a determined status of the main radio and/or the secondary radio.

### CROSS-REFERENCE TO RELATED APPLICATIONS

This application relates to co-pending U.S. patent application Ser. No. ______, entitled “AUTOMATED EVENT SEVERITY DETERMINATION IN AN EMERGENCY ASSISTANCE SYSTEM,” filed Mar. 15, 2013, co-pending U.S. patent application Ser. No. ______, entitled “DYNAMIC PROVISIONING OF PENDANT LOGIC IN EMERGENCY ASSISTANCE SYSTEMS,” filed Mar. 15, 2013, co-pending U.S. patent application Ser. No. ______, entitled “EVENT DETECTION AND REPORTING USING A GENERAL PURPOSE PROCESSOR AND A HARDENED PROCESSOR,” filed Mar. 15, 2013, and co-pending U.S. patent application Ser. No. ______, entitled “HIGH RELIABILITY ALERT DELIVERY USING WEB-BASED INTERFACES,” filed Mar. 15, 2013, all of which are assigned to the assignee hereof, and the entireties of which are herein incorporated by reference for all purposes.

### BACKGROUND

Emergency assistance systems typically include one or more wearable pendants or wall-mounted devices that allow a user to indicate an emergency by pushing a button on a wearable pendant or a wall-mounted device. The wearable pendant or wall mounted device can communicate a button push event with an on-site event detecting system. The event detecting system can forward the event and/or related information, such as an identifier or location of the event detecting system, to a remotely-located centralized station for determining whether to dispatch assistance. The event detecting system, or one or more devices coupled thereto, can allow for audio communication between the centralized station and the site via telephone line to attempt voice communication with the person that pressed the button (e.g., to determine whether assistance is desired).

Advances in technology have enabled emergency assistance systems that allow for communications between the event detecting system and one or more pendants, including voice communications, over more wireless network technologies, such as WiFi (e.g., wireless local area network (WLAN) or other technology based on IEEE 802.11 standards). Such systems typically depend on operation of another device and/or service, such as a WiFi hotspot or other network router, to facilitate communications between the pendants and event detecting system. Thus, where the device fails or is otherwise taken offline, this may disrupt functionality of the emergency assistance devices installed on-site, which may result in failure to report detected events. In some cases, the unreported events may be critical events, such as a pendant button push to request assistance, a detected fall, and/or the like.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein relate to utilizing multiple radios in a device of an emergency assistance system for improving reliability of event reporting. For example, the device can include a main radio for communicating with a component of the emergency assistance system, and at least one secondary radio for providing additional or alternative communication with the emergency assistance system, determining a location of the device, engaging an on-site event reporting mechanism of the emergency assistance system, and/or the like. In one example, the device can determine that the main radio has lost connection to the emergency assistance system, or at least a component thereof, or is otherwise not functioning properly, and can accordingly use the secondary radio to communicate with the emergency assistance system (e.g., at least until the main radio is online). For example, the main radio and secondary radio can provide communications using different wireless technologies.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements.

FIG. 1 is an aspect of an example emergency assistance system for detecting and reporting events.

FIG. 2 is an aspect of an example system for utilizing multiple radios to report detected events or for other purposes.

FIG. 3 is an aspect of example pendant in an emergency assistance system.

FIG. 4 is an aspect of an example methodology for reporting detected events over one or more radios.

FIG. 5 is an aspect of an example methodology for reporting detected events based on radio status.

FIG. 6 is an aspect of an example system in accordance with aspects described herein.

FIG. 7 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to employing multiple radios in a device of an emergency assistance system. The device can be an event detection component that detects and reports events to one or more components of the emergency assistance system. The device, for example, can include a wearable pendant, a wall-mounted device, etc., that wirelessly communicates with a device in the emergency assistance system. For example, wearable pendants can include various form factors, such as a pendant with a lanyard for wearing around the neck, a watch form factor for wearing on a wrist (e.g., where the watch can function as a watch and also include the pendant or components thereof), etc. The device can include a main radio to facilitate the wireless communication with the emergency assistance system and at least one secondary radio to provide an additional or alternative mechanism for reporting events. For example, where a connection is unavailable via the main radio (e.g., because the device is out-of-range, the main radio is not functioning properly, etc.), the secondary radio can be employed to at least one of report events to a component of the emergency assistance system, trigger an on-site event reporting mechanism, such as an external alarm that sounds an alarm tone and/or flashes lights or other visual indicators, and/or the like. The secondary radio can also be used to perform location determination of the device or other additional or alternative functions of the main radio. In an example, the main radio and secondary radio can provide communications using different wireless technologies.

As used in this application, the terms “component,” “module,” “system,” “device” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

FIG. 1 illustrates an example system 100 for employing multiple radios for communicating in an emergency assistance system. System 100 includes an event detecting component 102 for detecting occurrence of one or more events based on one or more measured parameters. The event detecting component 102 can communicate event information over a network 104 to an event processing component 106, in one example. An alerting component 108 can be provided as well to generate one or more alerts to one or more devices based on the detected event. For instance, where the components 102, 106, and 108 relate to an emergency assistance system, event detecting component 102 can be a wearable pendant, a wall-mounted device, or other mechanism deployed to detect one or more events related to a person at the site of deployment (e.g., in a home of the person, in an assisted-living facility at which the person is resident, etc.). Event processing component 106 processes events detected by the event detecting component 102 and determines whether to send one or more alerts related to the events using alerting component 108, such as an alert to a monitoring station at or near where the event detecting component 102 is deployed, an alert to emergency dispatch services, and/or the like.

System 100 can also include an event detecting system 110 that can communicate with multiple event detecting devices installed at a site, and may function as a gateway facilitating communicating between the event detecting devices and network 104. Thus, event detecting system 110 can communicate with event processing component 106 via network 104, and is accordingly coupled to network 104. This can include a wireless coupling, such as a WiFi connection to network 104 via a router or other network component, a cellular connection to network 104, etc., a wired coupling, such as over a local area network (LAN), and/or the like. System 100 can also include an external alarm 112 for notifying of one or more detected events. External alarm 112 can be coupled to event detecting system 110, which can operate the external alarm 112 to notify of events, and can include a speaker for broadcasting sound, one or more lights to illuminate, and/or other components to facilitate determining an approximate location of a detected event.

Event detecting component 102 can include a main radio 114 for communicating with one or more components of an emergency assistance system over a wireless connection, and a secondary radio 116 for providing additional or alternative communications to the emergency assistance system, location determination for the event detecting component 102, and/or the like. Network 104 can include a collection of nodes communicatively coupled with one another via one or more components (e.g., switches, routers, bridges, gateways, etc.), which can include, or can include access to, an Internet, intranet, etc. In addition, in an example, event processing component 106 and alerting component 108 can each be, or can collectively include, one or more servers purposed with performing at least a portion of the described functionalities. Thus, in one example, one or more of the components 106 or 108 can be distributed among multiple servers within network 104 in a cloud computing environment.

According to an example, event detecting component 102 can utilize main radio 114 to communicate with a component of an emergency assistance system, such as an event processing component 106. This can include communicating the component via a connection between main radio 114 and network 104 that may or may not include using event detecting system 110 as a gateway, as depicted. In either case, main radio 114 can be a WiFi (or other wireless local area network (WLAN) or IEEE 802.11 standard) radio, a cellular radio, etc., and can communicate with network 104 and/or event detecting system 110 via wireless connection thereto (e.g., a direct connection or through one or more intermediate components, such as a hotspot) that provides access to network 104 and/or event detecting system 110. In this example, during normal operation, event detecting component 102 can report detected events to event processing component 106 by communicating therewith over network 104 using main radio 114.

Secondary radio 116 can be another wireless radio and can operate using a different wireless technology and/or over a different frequency than main radio 114 to provide a different mechanism for communicating with event processing component 106 or other components of an emergency assistance system. Secondary radio 116, for example, can be an IEEE 802.15.4 (900 MHz), Bluetooth, ZigBee, or similar radio. In one example, secondary radio 116 can tether to another device with access to network 104. Event detecting component 102 can employ one or more secondary radios, such as secondary radio 116, to provide redundant communications of certain events to event processing component 106 by communicating with event detecting system 110 using the secondary radio 116, which can receive and forward communications to event processing component 106 over network 104.

In another example, event detecting component 102 can employ the one or more secondary radios to communicate with event processing component 106 (e.g., via event detecting system 110) alternatively to main radio 114. For example, this can occur when main radio 114 is detected as having no connection or otherwise not functioning properly. In yet another example, event detecting component 102 can utilize secondary radio 116 to allow triangulation of its location based at least in part on detecting signals from various event detecting systems 110 or external alarms 112 via secondary radio 116, and determining a location of event detecting component 102 based on signal strength and known location of the event detecting systems 110 or external alarms 112.

Moreover, in an example, secondary radio 116 can trigger event reporting by external alarm 112 for reporting an event where main radio 114 is not functioning properly and/or where event detecting system 110 has lost connection to network 104 or is also otherwise not functioning properly. In this example, secondary radio 116 can report events or related alarm instructions to the external alarm 112 (e.g., via event detecting system 110 or otherwise), which can cause external alarm 112 to sound a tone, illuminate lights, etc. to indicate an emergency based on the detected event. Where secondary radio 116 is not connected or is otherwise not functioning properly, event detecting component 102 can activate one or more local alarms on event detecting component 102 (e.g., via an integrated speaker, lights, etc.) to report the event.

FIG. 2 illustrates an example system 200 for using a main radio and at least one secondary radio to report events in an emergency assistance system. System 200 includes an event detecting component 102 that communicates with a network 104 and/or external alarm 112. As described, event detecting component 102 can be a wearable pendant, a wall-mounted switch, and/or other mechanism for detecting or otherwise triggering events in the emergency assistance system. Event detecting component 102 can communicate with network 104 and/or external alarm 112 through an on-site event detecting system, as shown previously in one example, though examples described herein are not so limited. Moreover, system 200 includes an event processing component 106 for receiving events from or related to event detecting component 106, and one or more listening devices 210 for obtaining signals from a secondary radio 116 of one or more event detecting components. Listening device 210 can be installed on-site and/or can communicate with an on-site event detecting system for reporting event related information to event processing component 106, in one example.

Event detecting component 102 can include a main radio 114 for communicating with an emergency assistance system to report events, receiving information for operating in the system, and/or the like, a secondary radio 116 for providing an additional or alternative mechanism for communicating with the system, and a radio status detecting component 202 for determining whether the main radio 114 and/or secondary radio 116 are connected to the emergency assistance system, functioning properly, and/or the like. Event detecting component 102 optionally includes an external alarm reporting component 204 for communicating with an external alarm to notify of reported events, a local alarm component 206 for activating one or more alarm features on event detecting component 102, and/or a location determining component 208 for obtaining and/or reporting a location of event detecting component 102.

According to an example, event detecting component 102 can utilize main radio 114 to communicate with network 104 (e.g., via an event detecting system or otherwise). Main radio 114 and secondary radio 116 can each be substantially any wireless radio, such as a WiFi or other WLAN radio, a cellular radio, a 900 MHz radio, a Bluetooth, ZigBee, or similar radio, etc., and each radio 114 and/or 116 can communicate with network 104 via one or more intermediate components (e.g., an event detecting system, another wireless device to which the radio 114 and/or 116 is tethered, and/or the like). In one example, the main radio 114 and secondary radio 116 are of different technologies to facilitate multiple modes of communication in the event that one communication mode fails. Event detecting component 102 can include additional secondary radios as well (not shown). In any case, event detecting component 102 may additionally or alternatively use secondary radio 116 to communicate with network 104 (e.g., via an event detecting system as a gateway to network 104 or otherwise).

In one example, radio status detecting component 202 can determine a status of the main radio 114 for determining whether to utilize secondary radio 116. For example, where radio status detecting component 202 determines that main radio 114 is not connected to network 104 (e.g., and/or not connected to a mechanism that provides access to network 104, such as a WiFi hotspot), event detecting component 102 can determine to employ secondary radio 116 to communicate with network 104 based on the status of main radio 114. For example, main radio 114 may lose connection due to moving out-of-range of the network, experiencing poor signal quality due to something blocking the signal to the network 104 or intermediate device, ceasing functioning properly (e.g., due to a hardware issue of the main radio 114), losing signal between an intermediate device (e.g., a hotspot) and network 104, and/or the like. Additionally, radio status detecting component 202 can determine other status parameters of main radio 114 that can cause secondary radio 116 to be employed, such as a collision rate of the main radio 114 over the wireless network, a network load or capacity, and/or the like. Where additional secondary radios are present, in an example, radio status detecting component 202 can similarly detect status of other secondary radios to determine one of the secondary radios to employ in providing contingent communication with the emergency assistance system to ensure high reliability.

In addition, event detecting component 102 can use secondary radio 116 to report events, or otherwise send instructions, to external alarm 112, which can sound tones, illuminate lights, and/or the like based on a received event or related instructions. In one example, event detecting component 102 can employ the secondary radio 116 to report events via external alarm 112 based on determining main radio 114 has lost connection or is otherwise not functioning properly, and thus cannot properly report the events. Additionally, for example, reporting events via external alarm 112 can be further based on radio status detecting component 202 detecting a connection between the secondary radio 116 and the event detecting system, but no connection to network 104 (e.g., via the event detecting system).

Moreover, in one example, radio status detecting component 202 can determine that secondary radio 116 is also not connected or otherwise is not functioning properly. This can include determining secondary radio 116 is not connected to network 104 or is not connected to an on-site event detecting system, as described. In this example, where event detecting component 102 detects and determines to report an event, event detecting component 102 can accordingly utilize local alarm component 206 to activate one or more local alarms at the event detecting component 102 (e.g., sounding a tone on a speaker, illuminating a light, etc.) since main radio 114 and secondary radio 116 are unable to report the event to the emergency assistance system, external alarms 112 or other components that can notify of the reported events.

Moreover, event detecting component 102 can employ main radio 114 and secondary radio 116, even where both have connections to network 104, to provide redundant reporting of all or certain events (e.g., critical events, such as discrete emergency button pushes, fall detections, etc.). Furthermore, for example, location determining component 208 can employ secondary radio 116 to listen to signals from one or more event detecting systems, or external alarms 112, deployed on site. For instance, event detecting component 102 can operate in an assisted-living facility with multiple event detecting systems or external alarms 112 that communicate with multiple event detecting components 102 to provide event detection and reporting throughout the facility. In this example, location determining component 208 can triangulate a location of event detecting component 102 based on the signal strengths and known locations of the event detecting systems or external alarms 112 at the facility. Event detecting component 102 can utilize the location for various purposes, including indicating a location for a detected event reported to the emergency assistance system (e.g., via network 104 using main radio 114 and/or secondary radio 116).

In another example, an event processing component 106 or other component of the emergency assistance system can triangulate the position of event detecting component 102 based at least in part on receiving signal strength measurements of signals transmitted by the secondary radio 116 at one or more listening devices 210 installed at the site. For example, the secondary radio 116 can transmit signals upon occurrence of a detected event. This can be based on radio status determining component 202 determining that main radio 114 is not functioning properly or in any case. Listening device 210 can receive the signals from secondary radio 116 and can measure a strength of the signals as received. Listening device 210 can indicate the received signal strength to event processing component 106 (e.g., via connection to network 104 through an event detecting system or otherwise). Signal strength measuring component 212 can obtain the signal strength measurements from listening device 210 and/or other listening devices within range of event detecting component 102. Triangulating component 214 can accordingly determine a location of event detecting component 102 based at least in part on the received signal strength measurements and known locations of the listening devices 210. The location can be used in reporting the event to the emergency assistance system. In one example, external alarm 112 can include a listening device 210 for receiving secondary radio signals from event detecting components and reporting the signal strength to an on-site event detecting system.

In addition, secondary radio 116 can communicate with listening device 210 to facilitate communicating with event processing component 106, or other components of an emergency assistance system, via a connection between listening device 210 and network 104. This connection can be a direct connection between listening device 210 and network 104 and/or a connection through one or more intermediaries, such as an event detecting system. In this regard, listening device 210 also has a secondary radio and another mechanism to communicate over network 104, such as a wired or wireless connection (e.g., WLAN radio, cellular radio, LAN port, etc.). In one example, radio status detecting component 202 can determine to utilize secondary radio 116 to communicate detected event information, as described, to listening device 210 upon determining that main radio 114 cannot communicate the information.

FIG. 3 illustrates an example pendant 300 for operation in an emergency assistance system. Pendant 300 can include one or more of the various components depicted to facilitate event detection and reporting by the pendant 300. For example, pendant 300 can include an emergency button 302 for indicating an emergency by activating the button, a processor 304, which can include a general purpose processor, for executing event detection and reporting logic, and a memory 306 to store instructions for executing the logic, data, or other information related to event detecting and reporting. Pendant 300 can also include a main radio 114 and a secondary radio 116, as described, which can be WiFi, cellular, 900 Mhz, Bluetooth, ZigBee, or similar radios to facilitate reporting events or other information to one or more components of an emergency assistance system.

Pendant 300 can also include a speaker 312 to render audio tones or messages, which can be a local piezo buzzer or similar mechanism, a microphone 314 to record audio, and a light emitting diode (LED) array 316, or similar illumination source, for displaying light for a detected event. Pendant 300 may also include a battery 318 to power the pendant, an accelerometer 320 to measure acceleration of the pendant 300, a digital barometer 322 to measure height change of the pendant 300, a thermometer 324 to measure ambient temperature, and a GPS receiver 326 to determine a GPS position of the pendant 300. Pendant 300 also optionally includes a radio status detecting component 202 for detecting whether main radio 114 and/or secondary radio 116 have a connection and/or are otherwise functioning properly, an external alarm reporting component 204 for communicating with one or more external alarms using secondary radio 116 to report events (e.g., via an event detecting system or otherwise), a local alarm component 206 for activating local alarms on the pendant (e.g., using speaker 312, LED array 316, etc.) in certain scenarios, and/or a location determining component 208 for triangulating a location of pendant 300 based on signals received at the secondary radio 116.

According to an example, pendant 300 can operate according to one or more defined thresholds for measured parameters of the various components to facilitate detecting events, such as fall detection, inactivity monitoring, environmental monitoring, etc. In addition, pendant 300 can provide for local alarming, reminder playback, audio recording, and/or the like. In one specific example, the pendant 300 can specify parameter thresholds for fall detection, which can include detecting an acceleration measurement above a threshold via accelerometer 320 combined with a height adjustment measurement over a threshold via digital barometer 322. Where such is detected, main radio 114 and/or secondary radio 116 can attempt to communicate a fall detection event to the emergency assistance system. External alarm reporting component 204, as described, can attempt to report the event or send instructions to an external alarm via secondary radio 116 (e.g., where communication with the emergency assistance system fails or otherwise). Additionally or alternatively, local alarm component 206 can cause LED array 316 can flash, speaker 312 can sound a tone, and/or the like (e.g., where communication with the emergency assistance system and/or external alarm fail, or otherwise). The thresholds and reporting functionality can be different for different defined profiles that may be provisioned to the pendant 300, in one example.

In another specific example, the pendant 300 can specify parameters for activity/inactivity monitoring, which can include inferring activity based on accelerometer 320 measurements, measurements of position over time from GPS receiver 326, etc. Pendant 300 can define parameter thresholds for detecting events related to too much inactivity (which may indicate the person is in distress). The thresholds may vary for different profiles, during different times of day, etc. For example, a minimum threshold for acceleration measurements via accelerometer 320 may be lower midday than overnight, as the person may be assumed to be sleeping overnight. In addition, in an example, the pendant 300 can define parameter thresholds for allowed location of the pendant measured by GPS receiver 326 (e.g., to facilitate range fencing of a person where an event is triggered when the pendant is determined to be outside of an allowed location range). In yet another example, the pendant 300 can specify parameter thresholds for detecting events based on temperature according to measurements by thermometer 324, which can also be specific for a given pendant. Thus, a lower range of temperature can be acceptable as specified for a person who prefers to keep their house (or other site of emergency assistance system installation) cooler.

Moreover, the pendant 300 can define parameters for certain audio playback via speaker 312, such as a reminder to take medicine played at certain times of day. It is to be appreciated that the audio files can be included in the logic or otherwise obtained and stored in memory 306. In another example, the audio can be streamed (e.g., over the main radio 114) as specified in the logic. The delivery mechanism, content, and instructions for playing the audio can all be defined in logic, which may be provisioned to pendant 300. In further examples, the logic can specify parameters related to event reporting, such as: an audio stream, volume, duration, etc. for sounding an alarm on speaker 312 for certain detected events; duration, intensity, pattern, color, etc. for flashing LEDs in LED array 316 for certain detected events; audio sampling duration for microphone 314 based on certain detected events; and/or the like. For instance, the audio sampling data from microphone 314 can be transmitted to the emergency assistance system for playback to personnel, automated triage to determine possible status of the person based on the audio sampling and other event data, etc.

In additional examples, the pendant 300 can operate one or more power management schemes to conserve power of the battery 318 (e.g., in certain detected contexts, such as main radio 114 failure or loss of connection, secondary radio 116 failure or loss of connection, etc.). In one example, where battery 318 is low, power management component 328 can disable accelerometer 320, digital barometer 322, thermometer 324, GPS receiver 326, etc. and/or can activate a periodic audio indicator via speaker 312 to notify of the low power state. The power management can be according to one or more defined power management schemes, which may be provided to the pendant 300. In one example, the power management scheme can continue to shutdown components while maintaining power to the emergency button 302 for as long as possible.

Moreover, in an example, the pendant 300 can define parameter thresholds for detecting a lost pendant event; for example, this can include detecting that the pendant 300 has not moved location over a certain period of time via GPS receiver 326 measurements, detecting the pendant 300 has been in a low power state during this time, determining that the pendant 300 is not in radio range (e.g., no connection via main radio 114 or secondary radio 116), and/or the like. The pendant 300 can also define reporting for the lost pendant event (e.g., activate a tone over speaker 312, display lights on LED array 316, etc.). In additional examples, pendant 300 can communicate with other devices, such as a vital statistic monitoring device (e.g., a sphygmomanometer, pulse rate detector, internal thermometer, etc.) to detect and/or report events related thereto.

As described previously, radio status detecting component 202 can determine a radio status for main radio 114 and/or secondary radio 116. Where main radio 114 has lost connection or is otherwise not functioning properly, pendant 300 can employ secondary radio 116 to report events to the emergency assistance system. It is to be appreciated that pendant 300 may also use secondary radio 116 in conjunction with main radio 114, where both have a connection to the emergency assistance system, to report all or certain critical events thereto. In addition, external alarm reporting component 204 can use secondary radio 116 to report events to an external alarm (not shown) for all events, certain critical events, and/or for such events only when main radio 114 is not connected or not functioning properly. Where secondary radio 116 is also not connected or not functioning properly, pendant 300 can use local alarm component 206 to engage one or more components, such as speaker 312, LED array 316, etc., to render local alarms. For example, local alarm component 206 can sound certain tones over speaker 312, illuminate certain lights on LED array 316, and/or the like.

In yet another example, location determining component 208 can utilize secondary radio 116 to triangulate a location of the pendant 300. The location can be used, for example, in reporting events to the emergency assistance system, tracking the pendant 300 by the emergency assistance system, and/or the like. In one example, pendant 300 may not have a GPS receiver 326 (and/or the GPS receiver 326 may be powered down or otherwise not receiving a GPS signal), and location determining component 208 can use triangulation to determine the location of pendant 300. As described, location determining component 208 can obtain, from secondary radio 116, measurements of signals from event detecting systems or external alarms installed on a campus of a facility within which the pendant 300 operates. Based on signal strength and known location of the event detecting systems or external alarms, location determining component 208 can triangulate the location of pendant 300, for example.

The above are examples of different pendant logic that can be utilized by pendant 300, and are not intended to limit possible logic that can be defined for the components of a pendant 300 (e.g., and/or provisioned to the pendant 300). In addition, in some examples, the logic can be context specific such that changes detected in a context or environment related to a person can result in generation and transmission of new logic provisioned to pendant 300. Also, in one specific example, main radio 114 can be an electric imp WiFi radio, and/or secondary radio 116 can be a radio conforming to IEEE 802.15.4 standards, such as MRF89XAM9A I/RM radio (900-928 MHz) by Microchip Technologies.

Referring to FIGS. 4 and 5, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 4 illustrates an example methodology 400 for reporting events in an emergency assistance system. At 402, it can be determined to report a detected event to an emergency assistance system. For example, this can be based at least in part on comparing measurements obtained from various components to one or more thresholds, as described (e.g., comparing accelerometer or digital barometer measurements to fall detection thresholds). At 404, a status of a main radio configured to communicate with the emergency assistance system can be detected. For example, the main radio can periodically report a status or respond to queries for a status. The status may indicate whether the main radio is connected to the emergency assistance system. This can include an indication of whether the main radio is connected to an intermediate device (e.g., a hotspot, an event detecting system, etc.) that connects to the emergency assistance system, whether the main radio hardware is functioning properly, and/or the like.

At 406, it can be determined based on the status whether the main radio is connected to the emergency assistance system. If so, at 408, the main radio is employed to report the detected event to the emergency assistance system. If the main radio is not connected to the emergency assistance system, at 410, a secondary radio is employed to report the detected event to the emergency assistance system. As described, in some examples, this can occur for certain or all detected events even without determining whether the main radio is connected to the emergency assistance system at 406. Optionally, at 412, the secondary radio can be used to determine a location. For example, the secondary radio can measure strength of signals from devices in the emergency assistance system for which a location is known, and a location can be triangulated based on these metrics. In another example, known devices of the emergency assistance system can measure a signal strength received from the secondary radio, and the received signal strength measurements along with the location of the known devices can be used to triangulate the location. In any case, in an example, the location can be reported as related to the event to facilitate locating where the event occurred.

FIG. 5 illustrates an example methodology 500 for reporting events in an emergency assistance system. At 502, it can be determined to report a detected event to an emergency assistance system. For example, this can be based at least in part on comparing measurements obtained from various components to one or more thresholds, as described (e.g., comparing accelerometer or digital barometer measurements to fall detection thresholds). At 504, it can be determined whether a main radio is connected to an emergency assistance system. This can include an indication of whether the main radio is connected to an intermediate device (e.g., a hotspot, an event detecting system, etc.) that connects to the emergency assistance system, whether the main radio hardware is functioning properly, and/or the like, and can be obtained by receiving a periodic status report from the main radio, querying the main radio for the status, etc. If the main radio is connected to the emergency assistance system, the main radio is employed, at 506, to report the event to the emergency assistance system.

If the main radio is not connected to the emergency assistance system at 504, it can be determined whether the secondary radio is connected at 508. For example, this can include determining whether the secondary radio is connected to the emergency assistance system (e.g., or an intermediate device connected thereto), connected to an event detecting system or related external alarm, and/or the like. For example, if the secondary radio is connected to an external alarm (e.g., via an event detecting system or otherwise), it can report events via the external alarm, as described. If the secondary radio is connected at 508, the secondary radio is employed, at 510, to report the event and/or a location to the emergency assistance system or an external alarm. As described, the secondary radio can be used in determining the location. If the secondary radio is not connected at 508, one or more local alarms can be employed, at 512, to report the event. As described, this can include sounding a tone over an integrated speaker, illuminating lights, and/or the like.

To provide a context for the various aspects of the disclosed subject matter, FIGS. 6 and 7 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 6, an exemplary environment 600 for implementing various aspects disclosed herein includes a computer 612 (e.g., desktop, laptop, server, hand held, programmable consumer or industrial electronics . . . ). The computer 612 includes a processing unit 614, a system memory 616 and a system bus 618. The system bus 618 couples system components including, but not limited to, the system memory 616 to the processing unit 614. The processing unit 614 can be any of various available microprocessors. It is to be appreciated that dual microprocessors, multi-core and other multiprocessor architectures can be employed as the processing unit 614.

The system memory 616 includes volatile and nonvolatile memory. The basic input/output system (BIOS), containing the basic routines to transfer information between elements within the computer 612, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 612 also includes removable/non-removable, volatile/non-volatile computer storage media. FIG. 6 illustrates, for example, mass storage 624. Mass storage 624 includes, but is not limited to, devices like a magnetic or optical disk drive, floppy disk drive, flash memory or memory stick. In addition, mass storage 624 can include storage media separately or in combination with other storage media.

FIG. 6 provides software application(s) 628 that act as an intermediary between users and/or other computers and the basic computer resources described in suitable operating environment 600. Such software application(s) 628 include one or both of system and application software. System software can include an operating system, which can be stored on mass storage 624, that acts to control and allocate resources of the computer system 612. Application software takes advantage of the management of resources by system software through program modules and data stored on either or both of system memory 616 and mass storage 624.

The computer 612 also includes one or more interface components 626 that are communicatively coupled to the bus 618 and facilitate interaction with the computer 612. By way of example, the interface component 626 can be a port (e.g., serial, parallel, PCMCIA, USB, FireWire . . . ) or an interface card (e.g., sound, video, network . . . ) or the like. The interface component 626 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 612 to output device(s) via interface component 626. Output devices can include displays (e.g., cathode ray tube (CRT), liquid crystal display (LCD), light emitting diode (LCD), plasma . . . ), speakers, printers and other computers, among other things.

According to an example, computer 612 can perform event detecting component functions, including radio selection and usage, as described. In this example, the processing unit(s) 614 can comprise or receive instructions related to selecting or otherwise utilizing a main radio and one or more secondary radios, and/or other aspects described herein. It is to be appreciated that the system memory 616 can additionally or alternatively store such instructions and the processing unit(s) 614 can be utilized to process the instructions. In addition, computer 612, or a portion thereof, can be used to perform functions of components of the emergency assistance system, such as an event processing component, alerting component, etc., in one example.

FIG. 7 is a schematic block diagram of a sample-computing environment 700 with which the subject innovation can interact. The environment 700 includes one or more client(s) 710. The client(s) 710 can be hardware and/or software (e.g., threads, processes, computing devices). The environment 700 also includes one or more server(s) 730. Thus, environment 700 can correspond to a two-tier client server model or a multi-tier model (e.g., client, middle tier server, data server), amongst other models. The server(s) 730 can also be hardware and/or software (e.g., threads, processes, computing devices). The servers 730 can house threads to perform transformations by employing the aspects of the subject innovation, for example. One possible communication between a client 710 and a server 730 may be in the form of a data packet transmitted between two or more computer processes.

The environment 700 includes a communication framework 750 that can be employed to facilitate communications between the client(s) 710 and the server(s) 730. Here, the client(s) 710 can correspond to program application components and the server(s) 730 can provide the functionality of the interface and optionally the storage system, as previously described. The client(s) 710 are operatively connected to one or more client data store(s) 760 that can be employed to store information local to the client(s) 710. Similarly, the server(s) 730 are operatively connected to one or more server data store(s) 740 that can be employed to store information local to the servers 730.

By way of example, one or more clients 710 can be pendants or other event detecting components that report events to server(s) 730 via communication framework 750. The one or more clients 710 may employ radios that utilize different communication frameworks 750 and/or different routes to connect with communication framework 750, as described herein.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A system for reporting events in an emergency assistance system, comprising:
a main radio using a main wireless technology for communicating with the emergency assistance system;
a secondary radio using a secondary wireless technology for providing additional or alternative communication with the emergency assistance system; and
an event detecting component configured to report detected events to the emergency assistance system over a network connection with the emergency assistance system using the main radio or the secondary radio.

2. The system of claim 1, wherein the secondary radio is configured to provide the additional or alternative communication through another wireless connection with an on-site event detecting system that communicates with the emergency assistance system.

3. The system of claim 1, further comprising a radio status detecting component for determining a status of the main radio, wherein the event detecting component reports detected events using the secondary radio based at least in part on the status of the main radio.

4. The system of claim 1, further comprising an external alarm reporting component configured to report the detected events to an external alarm using the secondary radio.

5. The system of claim 4, wherein the external alarm reporting component reports the detected events to the external alarm using the secondary radio based at least in part on a determined status of the main radio.

6. The system of claim 1, further comprising a local alarm component configured to utilize one or more local alarms to report the detected events.

7. The system of claim 6, wherein the local alarm component utilizes the one or more local alarms based at least in part on a determined main radio status of the main radio and a determined secondary radio status of the secondary radio.

8. The system of claim 1, further comprising a location determining component for triangulating a location based at least in part on measuring strength of signals received over the secondary radio.

9. The system of claim 8, wherein the event detecting component includes the location in reporting the detected events.

10. A method for reporting events in an emergency assistance system, comprising:
determining to report a detected event to the emergency assistance system;
detecting a status of a main radio configured to communicate with the emergency assistance system; and
employing a secondary radio to report the detected event where the status of the main radio indicates that there is no connection to the emergency assistance system.

11. The method of claim 10, wherein employing comprises employing the secondary radio to report the detected event to an on-site event detecting system for communicating to the emergency assistance system or to an external alarm.

12. The method of claim 11, further comprising:
detecting a status of the secondary radio; and
rendering one or more local alarms to report the detected event where the status of the secondary radio indicates no connection to the on-site event detecting system or the external alarm.

13. The method of claim 10, further comprising receiving signals from one or more on-site event detecting systems or external alarms using the secondary radio.

14. The method of claim 13, further comprising determining a location based at least in part on triangulation using a strength of the signals and known location of the one or more on-site event detecting systems or external alarms.

15. The method of claim 14, further comprising reporting the location to the emergency assistance system in reporting the detected event.

16. A computer-readable storage medium comprising computer-executable instructions that, when executed by a processor, cause the processor to:
determine to report a detected event to the emergency assistance system;
detect a status of a main radio configured to communicate with the emergency assistance system; and
employ a secondary radio to report the detected event where the status of the main radio indicates that there is no connection to the emergency assistance system.

17. The computer-readable storage medium of claim 16, wherein the computer-executable instructions cause the processor to employ the secondary radio to report the detected event to an on-site event detecting system for communicating to the emergency assistance system or to an external alarm.

18. The computer-readable storage medium of claim 17, wherein the computer-executable instructions further cause the processor to:
detect a status of the secondary radio; and
render one or more local alarms to report the detected event where the status of the secondary radio indicates no connection to the on-site event detecting system or the external alarm.

19. The computer-readable storage medium of claim 16, wherein the computer-executable instructions further cause the processor to receive signals from one or more on-site event detecting systems or external alarms via the secondary radio.

20. The computer-readable storage medium of claim 16, wherein the computer-executable instructions further cause the processor to determine a location based at least in part on triangulation using a strength of the signals and known location of the one or more on-site event detecting systems or external alarms.
